(19) United States
(12) Patent Application Publication
(10) Pub. No.: US 2015/0109719 A1
(43) Pub. Date: Apr. 23, 2015

(54) METHOD OF FORMING GRAPHENE ELECTRODE AND CAPACITOR INCLUDING THE SAME

(71) Applicant: ELECTRONICS AND TELECOMMUNICATIONS RESEARCH INSTITUTE, Daejeon (KR)

(72) Inventors: Ho-Gyeong YUN, Seoul (KR); In-Kyu YOU, Gongju-si (KR); Yong Suk YANG, Daejeon (KR); Sunghoon HONG, Daejeon (KR)

(73) Assignee: ELECTRONICS AND TELECOMMUNICATIONS RESEARCH INSTITUTE, Deajeon (KR)

(21) Appl. No.: 14/264,497

(22) Filed: Apr. 29, 2014

(30) Foreign Application Priority Data
Oct. 17, 2013 (KR) 10-2013-0124099

(51) Int. Cl. H01G 11/86; H01G 11/32

(52) U.S. Cl. CPC H01G 11/86; H01G 11/32
USPC 361/502; 427/80

(57) ABSTRACT

Provided is a method of forming a graphene electrode including providing a solution including graphenes on a substrate, pressing a mold having a pattern onto the substrate to fill up the solution in the pattern of the mold, applying a temperature and a pressure to the mold so that the graphenes are arranged in a vertical direction with respect to a surface of the substrate, removing the solution, and separating the mold from the substrate to form an electrode including the graphenes on the substrate.

### CROSS-REFERENCE TO RELATED APPLICATIONS

This U.S. non-provisional patent application claims priority under 35 U.S.C. §119 of Korean Patent Application No. 10-2013-0124099, filed on Oct. 17, 2013, the entire contents of which are hereby incorporated by reference.

### BACKGROUND OF THE INVENTION

The present invention disclosed herein relates to a method of forming a graphene electrode and a capacitor including the same, and more particularly, to a method of forming a graphene electrode including crossing graphenes arranged on the surface of a substrate and a capacitor including the same.

A capacitor is a device for storing electricity, that is, a storage battery. The capacitor is used in electronic appliances such as a refrigerator, a washing machine, TV, and the like, and in a circuit board of a computer, a cellular phone, and the like. The capacitor has two facing electrodes as a basic structure, and an insulator is included between the electrodes. The capacitor is classified as three types including an electrostatic capacitor, an electrolytic capacitor and an electrochemical capacitor.

The electrostatic capacitor has a small capacitance, however is capable of a high voltage charge/discharge. Particularly, the electrostatic capacitor may be used in a high voltage short pulse power system because of the fast discharge time thereof within a few ms. The electrolytic capacitor is a capacitor having a large capacitance and is widely used. A super capacitor is a kind of the electrochemical capacitor and is a storage device having long lifetime and high output, by which a large amount of electric energy is charged instantaneously, and high current is discharged or supplied instantaneously or continuously for a few seconds or a few minutes.

At present, the super capacitor uses an activated carbon, carbon nano tube, or graphene as an electrode material. Particularly, since the graphene has a high electrical conductivity, an effort to improve the performance of the super capacitor by using the graphene has been made. Therefore, when manufacturing a super capacitor having good properties by using the graphene, an electrode structure including crossing graphenes in a vertical direction with respect to a substrate is an ideal structure. However, an expensive processing cost is necessary for the arrangement of the graphenes in the vertical direction.

### SUMMARY OF THE INVENTION

The present disclosure provides a method of forming a graphene electrode, by which a processing unit cost may be decreased.

The present disclosure also provides a capacitor having improved performance.

The tasks to be solved by the present inventive concept is not limited to the above-described task, however other tasks not mentioned will be precisely understood from the following description by a person skilled in the art.

Embodiments of the inventive concept provide methods of forming a graphene electrode including providing a solution including graphenes on a substrate, pressing a mold having a pattern onto the substrate to fill up the solution in the pattern of the mold, applying a temperature and a pressure to the mold so that the graphenes are arranged in a vertical direction with respect to a surface of the substrate, removing the solution, and separating the mold from the substrate to form an electrode including the graphenes on the substrate.

In some embodiments, the graphenes in the solution may be distributed without orientation.

In other embodiments, the removing of the solution may include performing a heat treatment process or a drying process.

In still other embodiments, the providing of the solution may include dropping a drop of the solution onto the substrate, or coating the solution on the substrate for forming a solution layer.

In even other embodiments, the mold may include PDMS, polyurethane (PUA), polyvinyl chloride (PVC), silicon, silicon oxide, or nickel.

In other embodiments of the inventive concept, capacitors include a first substrate, a first graphene electrode disposed on the first substrate and including first graphenes arranged in a vertical direction with respect to a surface of the first substrate, a second substrate, a second graphene electrode disposed on the second substrate and facing the first graphene electrode, a vertical direction the second graphene electrode including second graphenes arranged in a vertical direction with respect to the surface of the second substrate, and a separator disposed between the first graphene electrode and the second graphene electrode.

In some embodiments, the first graphene electrode may further include an active material making a bond and/or a mixture with the first graphenes, or filling up between the first graphenes.

In other embodiments, the active material may be an oxide, a nitride, a mixture thereof, or an electrically conductive polymer material.

In still other embodiments, the first graphene electrode and the second graphene electrode may include convex regions and concave regions alternately and repeatedly arranged, respectively. The convex regions of the first graphene electrode may be disposed to face the convex regions of the second graphene electrode, and the concave regions of the first graphene electrode may be disposed to face the concave regions of the second graphene electrode.

In even other embodiments, the separator may be provided between the convex regions of the first graphene electrode and the second graphene electrode.

In yet other embodiments, the capacitor may further include first horizontal graphenes horizontally arranged with respect to the first substrate on the first substrate, and second horizontal graphenes horizontally arranged with respect to the second substrate on the second substrate.

In further embodiments, holes penetrating the separator may be formed in a portion of the first graphene electrode and the second graphene electrode adjacent to each other.

In still further embodiments, the capacitor may further include an electrolyte filling up between the first graphene electrode and the second graphene electrode.

In even further embodiments, the separator may include pores. A space between the first graphenes, a space between the second graphenes, and a whole or a portion of the pores may be filled up with the electrolyte.

In yet further embodiments, the first substrate and the second substrate may be a polymer substrate, a substrate coated with a metal material such as aluminum, a metal substrate, a substrate formed by using a mixture of a metal foil or silicon and glass.

The capacitor according to embodiments of the inventive concept includes an electrode having graphenes arranged in a vertical direction on the surface of a substrate. The above graphenes facilitate the transport of electrons more smoothly than the graphenes arranged horizontally with respect to a substrate, thereby accomplishing a capacitor having good electrochemical properties.

The method of forming a graphene electrode according to embodiments of the inventive concept includes pressing a mold on a substrate supplied with a solution including graphenes, and arranging the graphenes by applying constant temperature and pressure to the mold so as to arrange the graphenes in a vertical direction on the surface of the substrate. Accordingly, the graphenes may be arranged in a vertical direction on the surface of the substrate without an expensive processing cost.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a cross-sectional view of a capacitor according to the first embodiment of the inventive concept;

FIG. 2 is a photographic image of graphenes arranged in a vertical direction with respect to the surface of a substrate according to the first embodiment of the inventive concept;

FIG. 3 is a cross-sectional view of a capacitor according to the second embodiment of the inventive concept;

FIG. 4 is a cross-sectional view of a capacitor according to the third embodiment of the inventive concept;

FIG. 5 is a cross-sectional view of a capacitor according the fourth embodiment of the inventive concept;

FIG. 6 is a cross-sectional view of a capacitor according the fifth embodiment of the inventive concept;

FIGS. 7A to 7E are cross-sectional views illustrating a method of forming a graphene electrode included in a capacitor according to exemplary embodiments of the inventive concept;

FIGS. 8A to 8E are cross-sectional views illustrating a method of forming a graphene electrode included in a capacitor according to another exemplary embodiments of the inventive concept; and

FIGS. 9A to 9D are cross-sectional views illustrating a method of forming a graphene electrode included in a capacitor according to further another exemplary embodiments of the inventive concept.

### DETAILED DESCRIPTION OF PREFERRED EMBODIMENTS

The advantages and the features of the inventive concept, and methods for attaining them will be described in example embodiments below with reference to the accompanying drawings. The inventive concept may, however, be embodied in different forms and should not be construed as limited to the embodiments set forth herein. Rather, these embodiments are provided so that this description will be thorough and complete, and will fully convey the scope of the present inventive concept to those skilled in the art. The inventive step may be defined only by the scope of the claims, and like reference numerals refer to like elements throughout.

The terminology used herein is for the purpose of describing particular example embodiments only and is not intended to be limiting of the present inventive concept. As used herein, the singular forms are intended to include the plural forms as well, unless the context clearly indicates otherwise. It will be further understood that the terms “comprises” and/or “comprising,” when used in this specification, specify the presence of stated features, steps, operations, and/or devices, but do not preclude the presence or addition of one or more other features, steps, operations, and/or devices thereof. In addition, example embodiments are described herein with reference to cross-sectional views and/or plan views that are schematic illustrations of idealized example embodiments. In the drawings, the sizes and relative sizes of layers and regions may be exaggerated for effective explanation of technical contents. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, a region illustrated as a rectangle will, typically, have rounded or curved features. Thus, the regions illustrated in the figures are schematic in nature and their shapes are not intended to illustrate the actual shape of a region of a device and are not intended to limit the scope of the present inventive concept.

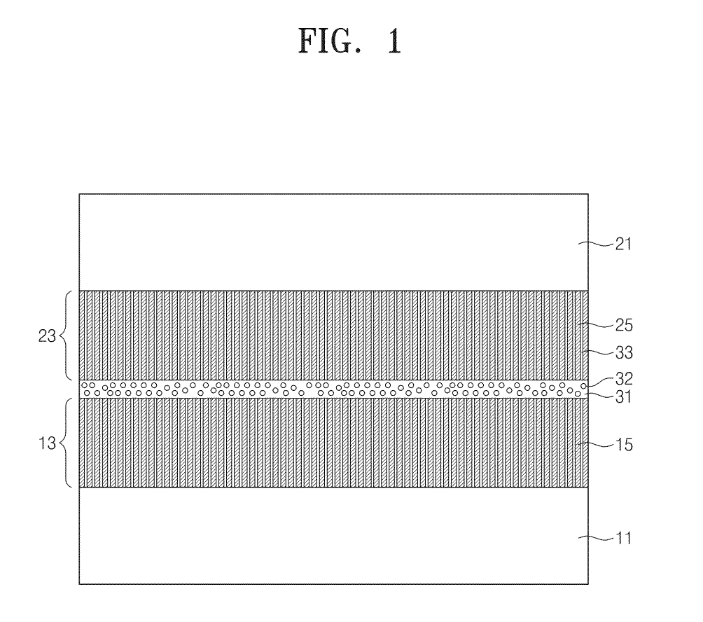

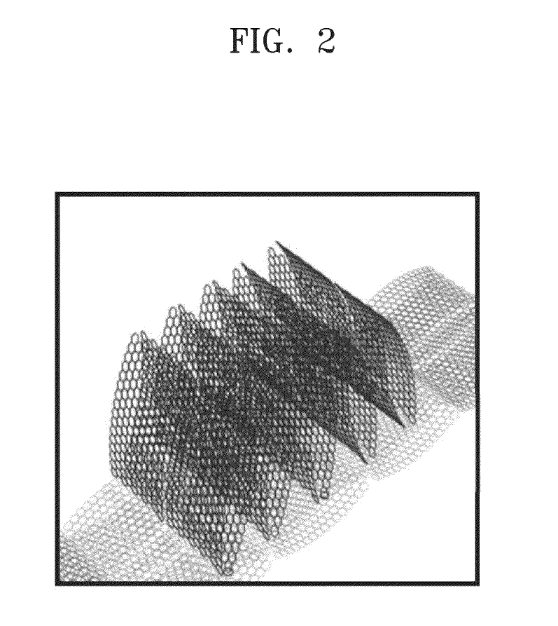

FIG. 1 is a cross-sectional view of a capacitor according to the first embodiment of the inventive concept. FIG. 2 is a photographic image of graphenes arranged in a vertical direction with respect to the surface of a substrate according to the first embodiment of the inventive concept.

Referring to FIG. 1, a capacitor includes a first substrate 11 and a second substrate 21 facing to each other, a first graphene electrode 13 formed on the first substrate 11, a second graphene electrode 23 formed on the second substrate 21, and a separator 31 provided between the first graphene electrode 13 and the second graphene electrode 23.

The first substrate 11 and the second substrate 21 may be metal-based substrates. For example, the first substrate 11 and the second substrate 21 may be a polymer substrate, a substrate coated with a metal material such as aluminum, a metal substrate, or a substrate obtained by mixing a metal foil or silicon and glass.

The first graphene electrode 13 may include first graphenes 15 arranged in a vertical direction on the top surface of the first substrate 11. The second graphene electrode 23 may include second graphenes 25 facing the top surface of the first substrate 11 and arranged in a vertical direction on the bottom surface of the second substrate 21. The first graphene electrode 13 and the second graphene electrode 23 may have a thickness ranging from about a few hundreds nm to about a few hundreds μm. When the thicknesses of the first and second graphene electrodes 13 and 23 are too small, the energy storage capacity of the capacitor may be decreased, and when the thicknesses are too large, the cost of raw materials may be increased, and the movement of an electrolyte 33 may not be smooth.

Graphene is a material making a two-dimensional planar structure in which carbon atoms are connected in a honey comb type of a hexagonal shape. Referring to FIG. 2, it would be confirmed that the graphenes are arranged in a vertical direction.

According to exemplary embodiments, the first graphenes 15 and the second graphenes 25 may be arranged in a vertical direction with respect to the surface of the first and second substrates 11 and 21 so that the first graphenes 15 and the second graphenes 25 may have large surface areas. Thus, mobility of electrons may be increased. Therefore, a capacitor having good electrochemical properties may be accomplished.

The separator 31 may prevent an electrical short circuit between the first graphene electrode 13 and the second graphene electrode 23. The separator 31 may include pores 32. The separator 31 may be a micro porous membrane formed by using at least one polymer selected from the group consisting of polyethylene (PE), polypropylene (PP), polyvinylidene fluoride (PVDF), polyvinylidene chloride, polyacrylonitrile (PAN), polyacrylamide (PAAm), polytetrafluoroethylene (PTFE), polysulfone, polyethersulfone (PES), polycarbonate (PC), polyamide (PA), polyimide (PI), polyethylene oxide (PEO), polypropylene oxide(PPO), a cellulose-based polymer and a polyacryl-based polymer.

A space between the first graphene electrode 13 and the second graphene electrode 23 may be filled up with the electrolyte 33. Particularly, the whole or a portion of the space between the first graphenes 15 and the space between the second graphenes 25 may be filled up with the electrolyte 33. In addition, the whole or a portion of the pores 32 included in the separator 31 may be filled up with the electrolyte 33. The electrolyte 33 may be an organic electrolyte including a non-lithium salt such as TEABF4, TEMABF4, or at least one lithium salt selected from the group consisting of LiPF6, LiBF4, LiClO4, LiN(CF3 SO2)2, CF3SO3Li, LiC(SO2CF3)3, LiAsF6 and LiSbF6, or a mixture thereof.

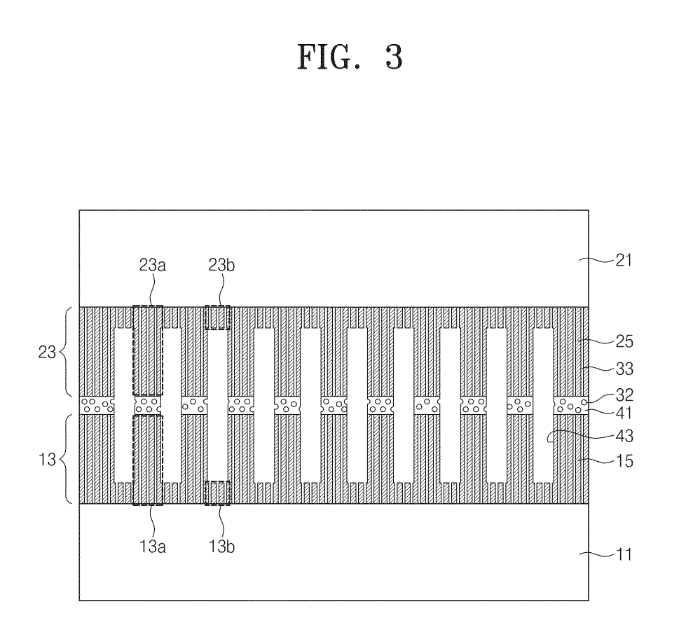

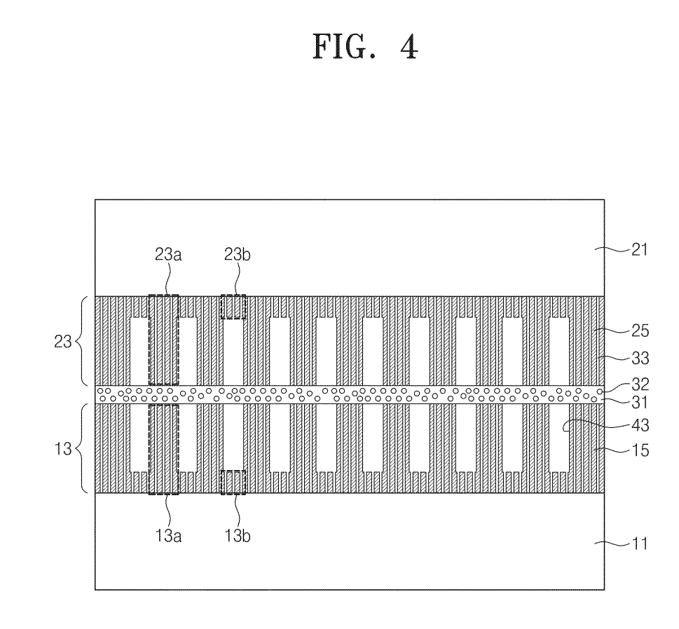

FIG. 3 is a cross-sectional view of a capacitor according to the second embodiment of the inventive concept. FIG. 4 is a cross-sectional view of a capacitor according the third embodiment of the inventive concept. For brevity of explanation, in the embodiments illustrated in FIGS. 3 and 4, the same reference numerals are designated for substantially the same elements as those in the first embodiment. The explanation on corresponding elements will be omitted.

Referring to FIGS. 3 and 4, the first graphene electrode 13 formed on the first substrate 11 may include convex regions 13a and concave regions 13b alternately and repeatedly arranged. The first graphene electrode 13 may include a top surface, a bottom surface and side walls. Particularly, the convex regions 13a of the first graphene electrode 13 includes the top surface of the first graphene electrode 13, and the concave regions 13b of the second graphene electrode 23 includes the bottom surface of the first graphene electrode 13. The side walls of the first graphene electrode 13 may be formed by extending the top surface of the first graphene electrode 13 and the bottom surface of the first graphene electrode 13. The first graphenes 15 in the convex regions 13a may be longer than the second graphenes 25 in the concave regions 13b.

Similarly, the second graphene electrode 23 formed on the second substrate 21 may include convex regions 23a and concave regions 23b alternately and repeatedly arranged. The second graphene electrode 23 may be disposed facing the first graphene electrode 13 with a separating space. Particularly, the convex regions 23a of the second graphene electrode 23 may be disposed so as to face the convex regions 13a of the first graphene electrode 13, and the concave regions 23b of the second graphene electrode 23 may be disposed so as to face the concave regions 13b of the first graphene electrode 13.

A separating pattern 41 may be disposed between the convex regions 13a of the first graphene electrode 13 and the convex regions 23a of the second graphene electrode 23.

A hole 43 surrounded by the side walls of the first graphene electrode 13 and the side walls of the second graphene electrode 23 may be formed. The first graphenes 15 and the second graphenes 25 included in the concave regions 13b and 23b may be exposed by the hole 43.

Meanwhile, as illustrated in FIG. 4, the separator 31 may be provided between the first graphene electrode 13 and the second graphene electrode 23. The holes 43 may be separated by the separator 31 so that the separated holes 43 may face to each other and may be formed on the first graphene electrode 13 and the second graphene electrode 23, respectively.

The whole or a portion of the holes 43 may be filled up with the electrolyte 33 filling up a space between the first graphene electrode 13 and the second graphene electrode 23.

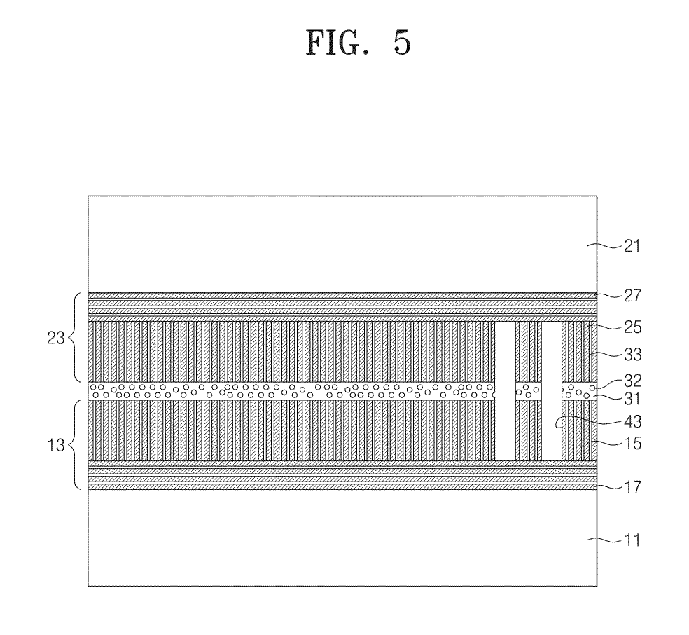

FIG. 5 is a cross-sectional view of a capacitor according the fourth embodiment of the inventive concept. For brevity of explanation, the same reference numeral is used for substantially the same elements as those in the first embodiment, and the explanation of corresponding elements will be omitted.

Referring to FIG. 5, the first graphene electrode 13 may include first horizontal graphenes 17 stacked on the first substrate 11 and first graphenes 15 disposed on the first horizontal graphenes 17. The first horizontal graphenes 17 may be horizontally arranged with respect to the top surface of the first substrate 11, and first graphenes 15 may be vertically arranged with respect to the first horizontal graphenes 17. Similarly, the second graphene electrode 23 may include second horizontal graphenes 27 stacked on the second substrate 21 and second graphenes 25 disposed on the second horizontal graphenes 27. The second horizontal graphenes 27 may be horizontally arranged with respect to the bottom surface of the second substrate 21 facing the top surface of the first substrate 11. The second graphenes 25 may be vertically arranged with respect to the second horizontal graphenes 27.

A separator 31 may be formed between the first graphene electrode 13 and the second graphene electrode 23. In parts of the first graphene electrode 13 and the second graphene electrode 23, holes 43 penetrating through the separator 31 may be formed.

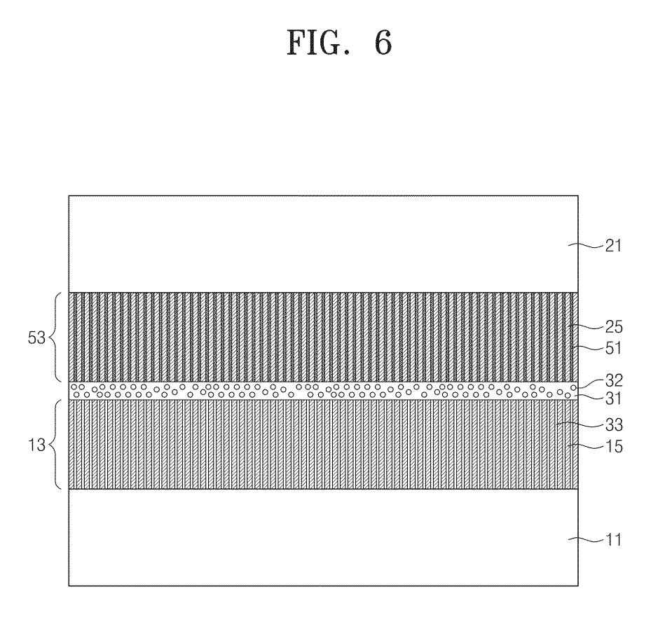

FIG. 6 is a cross-sectional view of a capacitor according the fifth embodiment of the inventive concept. For brevity of explanation, in the illustrated embodiment in FIG. 6, the same reference numerals may be used for the substantially the same elements as those in the first embodiment, and the explanation of corresponding elements will be omitted.

Referring to FIG. 6, the first graphene electrode 13 may include the first graphenes 15 vertically arranged with respect to the top surface of the first substrate 11. An electrode active material layer 53 formed on the second substrate 21 may include an active material 51 and the second graphenes 25 vertically arranged with respect to the bottom surface of the second substrate 21. The active material 51 may be combined and/or mixed with the second graphenes 25. Further, the active material 51 may fill up a space between the second graphenes 25. The active material 51 may be a material having an electronic resistance due to a faradaic reaction, and may be an oxide, a nitride, a mixture thereof or an electrically conductive polymer material.

The oxide may include, for example, a lithium containing metal oxide, a lead containing oxide, a manganese containing oxide, a ruthenium containing oxide, a vanadium containing oxide, a cobalt containing oxide or a nickel containing oxide. The nitride may be, for example, a vanadium containing nitride. The electrically conductive polymer material may be, for example, a PA-based polymer material based on polyacetylene, a PANI-based polymer material based on polyaniline, a PPy-based polymer material based on polypyrrole, a PTh-based polymer material based on polythiophene, a PEDOT-based polymer material based on poly(3,4-ethylenedioxylthiophene), a PPV-based polymer material based on poly(phenyl vinylene) or a PF-based polymer material based on polyfluorene.

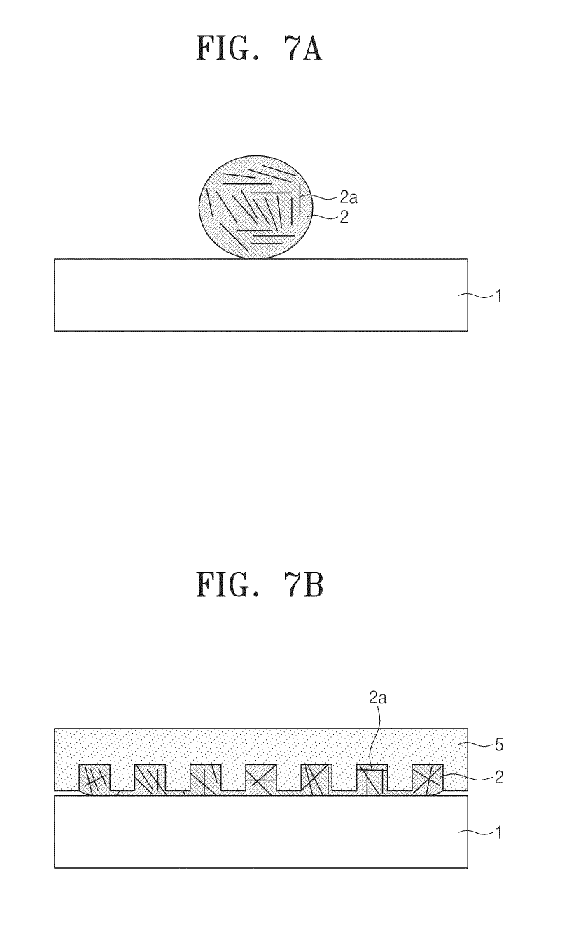

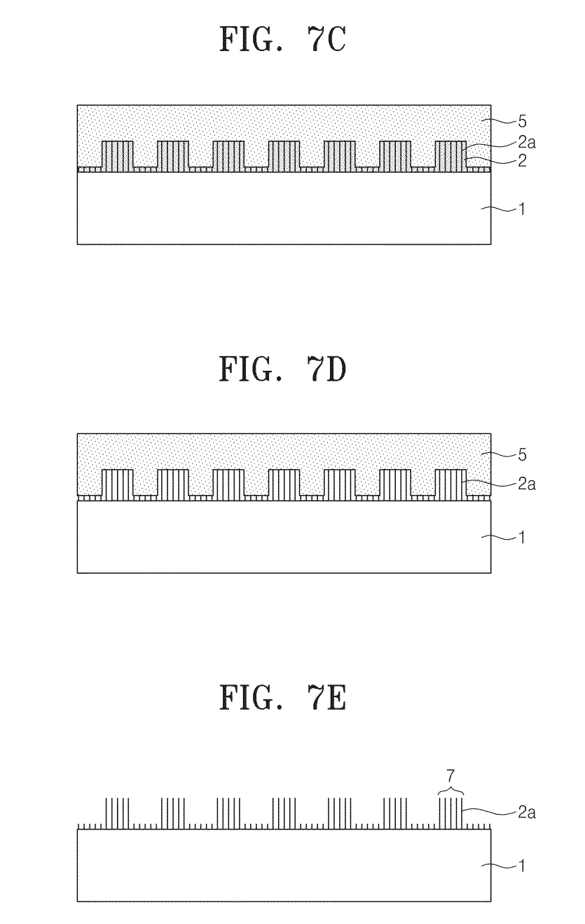

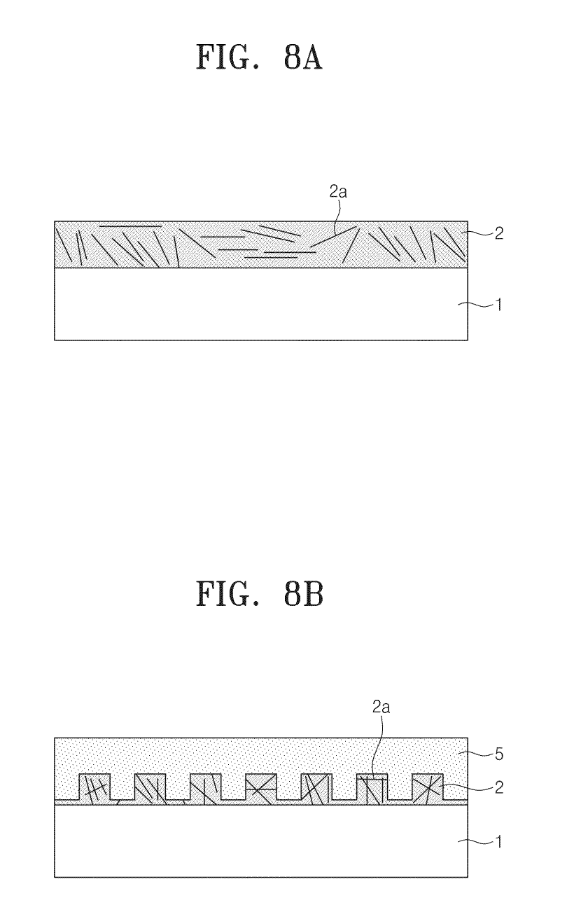

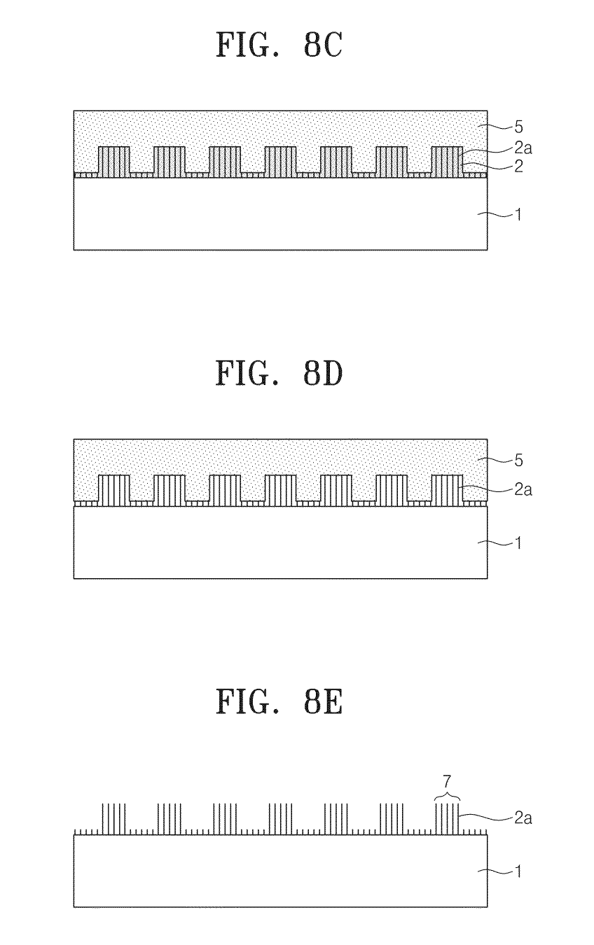

FIGS. 7A to 7E are cross-sectional views illustrating a method of forming a graphene electrode included in a capacitor according to exemplary embodiments of the inventive concept. FIGS. 8A to 8E are cross-sectional views illustrating a method of forming a graphene electrode included in a capacitor according to another exemplary embodiments of the inventive concept.

Referring to FIGS. 7A and 8B, a solution 2 including graphenes 2a is dropped on a substrate 1. The graphenes 2a may be distributed in a drop of the solution 2 without orientation. The solution 2 may be an organic solvent used as a dispersing solution. The substrate 1 may be a polymer substrate, a substrate coated with a metal material such as aluminum, a metal substrate, a substrate formed by mixing a metal foil or silicon and glass. As illustrated in FIG. 7A, the solution 2 may have a drop shape. Alternatively, as illustrated in FIG. 8A, the solution 2 may be coated on the substrate 1 as a layer shape. The solution 2 may be coated on the substrate 1 by a spin coating method.

Referring to FIGS. 7B and 8B to 7C and 8C, a mold 5 having a pattern is pressed on the substrate 1 so that the patterns of the mold 5 may be filled up with the solution 2, and the graphenes 2a may be vertically arranged with respect to the surface of the substrate 1. The graphenes 2a may be arranged in a vertical direction with respect to the surface of the substrate 1 while pressing the mold 5 onto the substrate 1 with a constant temperature and a constant pressure. Particularly, when the substrate 1 is pressurized by the mold 5, the graphenes 2a may be arranged in a vertical direction with respect to the surface of the substrate by a capillary force. The temperature may be from about a few tens ° C. to about a few hundreds ° C. The pressure may be from about 1 atm to about a few tens atm. The mold 5 may include a polymer material (for example, PDMS, polyurethane (PUA), polyvinyl chloride (PVA)), silicon, silicon oxide, or nickel.

According to the exemplary embodiments, the graphenes 2a randomly dispersed in the solution 2 may be arranged in a vertical direction with respect to the surface of the substrate 1 by using the mold 5 by means of a printing process, and a processing cost may be minimized.

Referring to FIGS. 7D and 8D, the solution 2 are removed, thereby remaining only the graphenes 2a between the substrate 1 and the mold 5. The solution 2 may be removed through a heat treatment process or a drying process.

Referring to FIGS. 7E and 8E, the mold 5 is separated from the substrate 1, and an electrode 7 including the graphenes 2a arranged in vertical direction with respect to the surface of the substrate 1 may be formed on the substrate 1.

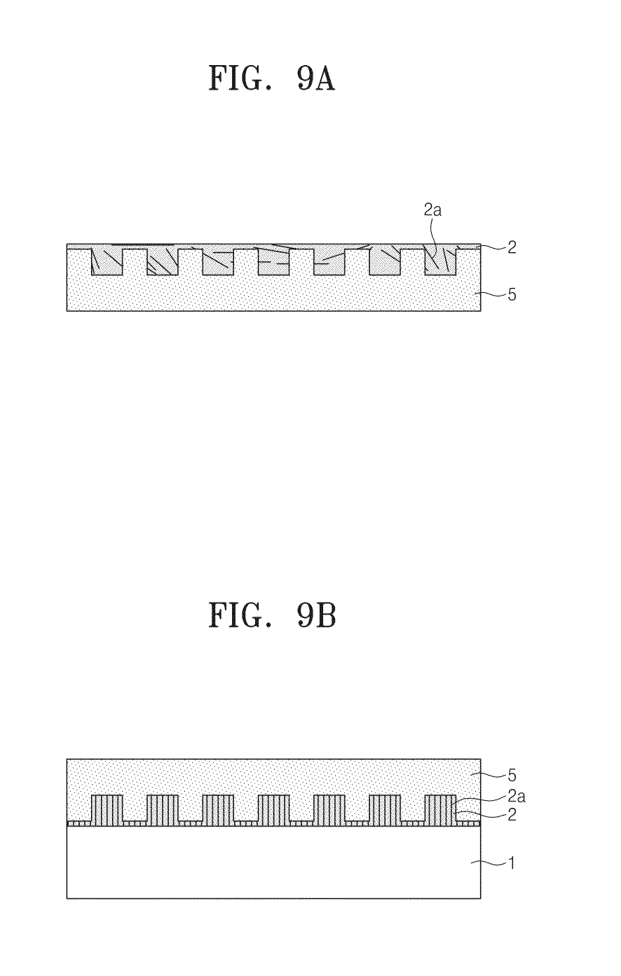

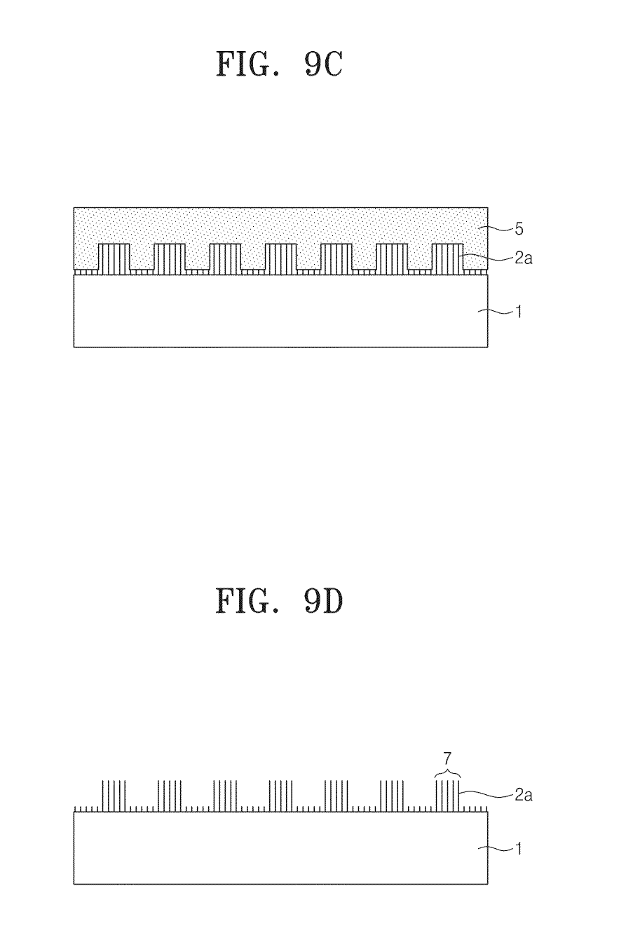

FIGS. 9A to 9D are cross-sectional views illustrating a method of forming a graphene electrode included in a capacitor according to further another exemplary embodiments of the inventive concept. For brevity of explanation, in further another embodiments illustrated in FIGS. 9A to 9D, the same reference numerals are used for the substantially same elements as those in the first embodiment, and the explanation of corresponding elements will be omitted.

Referring to FIG. 9A, a solution 2 in which the graphenes 2a are dispersed randomly is coated on the mold 5 to fill up the patterns with the solution 2.

Referring to FIGS. 9B and 9C, the mold 5 filled with the solution 2 is pressed onto the surface of the substrate 1 with a constant temperature to arrange the graphenes 2a in a vertical direction with respect to the surface of the substrate 1. After arranging the graphenes 2a, the solution 2 may be removed through a heat treatment process or a drying process.

Referring to FIG. 9D, the mold 5 is separated from the substrate 1, and an electrode 7 including the graphenes 2a arranged in a vertical direction with respect to the surface of the substrate 1 may be formed on the substrate 1.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of forming a graphene electrode comprising:
providing a solution including graphenes on a substrate;
pressing a mold having a pattern onto the substrate to fill up the solution in the pattern of the mold;
applying a temperature and a pressure to the mold so that the graphenes are arranged in a vertical direction with respect to a surface of the substrate;
removing the solution; and
separating the mold from the substrate to form an electrode including the graphenes on the substrate.

2. The method of forming a graphene electrode of claim 1, wherein the graphenes in the solution are distributed without orientation.

3. The method of forming a graphene electrode of claim 1, wherein the removing of the solution comprises performing a heat treatment process or a drying process.

4. The method of forming a graphene electrode of claim 1, wherein the providing of the solution comprises dropping a drop of the solution onto the substrate, or coating the solution on the substrate for forming a solution layer.

5. The method of forming a graphene electrode of claim 1, wherein the mold comprises PDMS, polyurethane (PUA), polyvinyl chloride (PVC), silicon, silicon oxide, or nickel.

6. A capacitor comprising:
a first substrate;
a first graphene electrode disposed on the first substrate and including first graphenes arranged in a vertical direction with respect to a surface of the first substrate;
a second substrate;
a second graphene electrode disposed on the second substrate and facing the first graphene electrode, the second graphene electrode including second graphenes arranged in a vertical direction with respect to the surface of the second substrate; and
a separator disposed between the first graphene electrode and the second graphene electrode.

7. The capacitor of claim 6, wherein the first graphene electrode further comprises an active material making a bond and/or a mixture with the first graphenes, or filling up between the first graphenes.

8. The capacitor of claim 7, wherein the active material is an oxide, a nitride, a mixture thereof, or an electrically conductive polymer material.

9. The capacitor of claim 6, wherein the first graphene electrode and the second graphene electrode include convex regions and concave regions alternately and repeatedly arranged, respectively, and wherein the convex regions of the first graphene electrode are disposed to face the convex regions of the second graphene electrode, and the concave regions of the first graphene electrode are disposed to face the concave regions of the second graphene electrode.

10. The capacitor of claim 9, wherein the separator is provided between the convex regions of the first graphene electrode and the second graphene electrode.

11. The capacitor of claim 6, further comprising:
first horizontal graphenes horizontally arranged with respect to the first substrate on the first substrate; and
second horizontal graphenes horizontally arranged with respect to the second substrate on the second substrate.

12. The capacitor of claim 11, wherein holes penetrating the separator are formed in a portion of the first graphene electrode and the second graphene electrode adjacent to each other.

13. The capacitor of claim 6, further comprising an electrolyte filling up between the first graphene electrode and the second graphene electrode.

14. The capacitor of claim 13, wherein the separator includes pores, and a space between the first graphenes, a space between the second graphenes, and a whole or a portion of the pores are filled up with the electrolyte.

15. The capacitor of claim 6, wherein the first substrate and the second substrate is a polymer substrate, a substrate coated with a metal material such as aluminum, a metal substrate, a substrate formed by using a mixture of a metal foil or silicon and glass.
